(19) United States
(12) Patent Application Publication
(10) Pub. No.: US 2006/0102551 A1
(43) Pub. Date: May 18, 2006

(54) HOT OIL POT

(76) Inventor: Doris B. Brown, Baton Rouge, LA (US)

Correspondence Address: REGINALD F ROBERTS JR, PO BOX 4535, BATON ROUGE, LA, 70821-4535, US

(21) Appl. No.: 10/904,618

(22) Filed: Nov. 18, 2004

(51) Int. Cl. B01D 24/38

(52) U.S. Cl. 210/466; 210/470; 210/473

(57) ABSTRACT

A hot oil pot for holding and purifying cooking oil used in residencies. One construction of the pot includes (a) a container for the oil, and (b) a filter for removing solids from the oil. The container has a side extension for discharging the oil from the container. One end of the extension is attached to the container. The filter is at the other end of the extension. Another construction of the pot includes (a) a container for the oil, (b) a filter for filtering the oil, and (c) another filter for refiltering the oil. The filters are so arranged that the oil passes first through one filter and then through the other filter. Both constructions of the hot oil pot are arranged so that filtered oil can be poured out through an extension attached to a side of the container.

### BACKGROUND OF INVENTION

The present invention relates to pots for holding and dispensing hot liquids. More particularly, the invention relates to pots for holding and dispensing hot cooking oils. Technology for removing solid impurities from cooking oils on an industrial scale is described in U.S. Pat. Nos. 6,235,193 and 5,846,409. However, there is at the present time no technology available to residencies for receiving and holding hot cooking oil which contains solid impurities, and for dispensing the hot cooking oil for reuse after the solid impurities have been removed. The present invention provides such technology. It will not only provide a convenient place to store used cooking oil, but it will also save the consumer the cost of purchasing cooking oil that may otherwise be used only once.

### SUMMARY OF INVENTION

The present invention, in a first aspect, provides a hot oil pot comprising (a) a container for the oil, the container including a chamber for retaining the oil, and a lateral extension for discharging the oil from the chamber, the lateral extension having a first end attached to the chamber, and a freely-disposed second end; and (b) a filter disposed at the second end of the lateral extension, for removing solids from the oil. The pot is sized, constructed, and arranged so that the pot can be operated at atmospheric pressure, and can be lifted, tilted, and manipulated by hand.

In a second aspect the invention provides a hot oil pot comprising (a) a container for the oil, the container including a chamber for retaining the oil, and a lateral extension for discharging the oil from the chamber, the lateral extension having a first end attached to the chamber, and a freely-disposed second end; (b) a first filter, for filtering the oil; and (c) a second filter, arranged for series flow through the first filter into and through the second filter, whereby oil that has been filtered by passage through the first filter is re-filtered by passage through the second filter. The pot is sized, constructed, and arranged so that the pot can be operated at atmospheric pressure, and can be lifted, tilted, and manipulated by hand.

### BRIEF DESCRIPTION OF DRAWINGS

FIG. 1 is a schematic representation of a first embodiment of a hot oil pot, made in accordance with the principles of the present invention.

FIG. 2 is a schematic representation of a second embodiment of a hot oil pot, made in accordance with the principles of the present invention.

### DETAILED DESCRIPTION

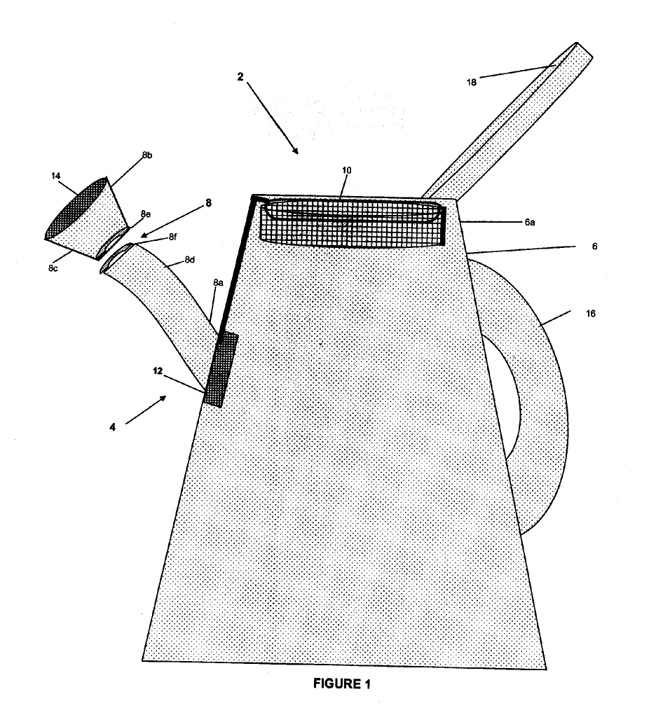

More specifically, reference is made to FIG. 1, in which is shown a first embodiment of a hot oil pot, made in accordance with the principles of the present invention, and generally designated by the numeral 2.

The hot oil pot 2 comprises a container 4 for the oil. The container 4 includes a chamber 6 for retaining the oil, and a lateral extension 8 for discharging the oil from the chamber 6. The lateral extension 8 has a first end 8a that is attached to the chamber 6, and a second end 8b that is freely disposed. The hot oil pot 2 includes three filters. A first filter 10 is disposed at the upper end 6a of the chamber 6. A second filter 12 is disposed at the first end 8a of the lateral extension 8. A third filter 14 is disposed at the second end 8b of the lateral extension 8.

The second end 8b of the lateral extension 8 beneficially comprises a terminal first portion 8c of the lateral extension 8. The terminal first portion 8c of the lateral extension 8 is separable from a remaining second portion 8d of the lateral extension 8. The first and second portions 8c and 8d of the lateral extension 8 include matching threads 8e, 8f. The first and second portions 8c, 8d of the lateral extension 8 are connected to one another by engaging the matching threads 8e, 8f, and are disconnected from one another by disengaging the matching threads 8e, 8f.

The first, second, and third filters 10, 12, and 14 are arranged for series flow. Used hot oil is poured into the upper end 6a of the chamber 6, passes through the first filter 10, and collects in the chamber 6. When ready for reuse, the oil is poured out through the second filter 12 and the lateral extension 8. The oil is then discharged from the second end 8b of the lateral extension 8 after passing through the third filter 14.

Manipulation of the container 4 is facilitated by a handle 16, and closure by a lid 18.

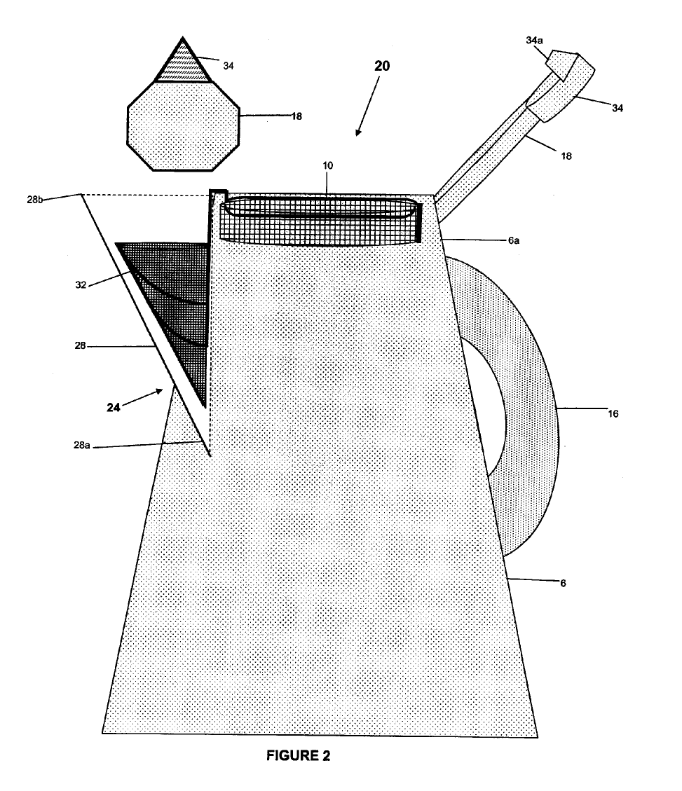

Reference is now made to FIG. 2, in which is shown a second embodiment of a hot oil pot, made in accordance with the principles of the present invention, and generally designated by the numeral 20.

The hot oil pot 20 comprises the chamber 6, the handle 16, the lid 18, and the first filter 10 which constitute a portion of the first embodiment 2 of a hot oil pot. A container 24 comprises the chamber 6 and a lateral extension 28 having a first end 28a attached to the chamber 6, and a second end 28b that is freely disposed.

A second filter 32 is disposed in the lateral extension 28. A third filter 34 forms a cap which closes the second end 28b of the lateral extension 28. The filter 34 is beneficially attached to the lid 18, which is pivotally connected to the upper end 6a of the chamber 6. The lid 18 and the filter 34 are constructed and arranged so that the chamber 6 and the lateral extension 28 are closed by the lid 18 and the filter 34, respectively. A snap or hook 34a, attached to the filter 34, secures the lid 18 and the filter 34 in place.

The first, second, and third filters 10, 32, and 34 are arranged for series flow. Used hot oil is poured into the upper end 6a of the chamber 6, passes through the first filter 10, and collects in the chamber 6. When the oil is ready for reuse, the chamber 6 and the lateral extension 28 are closed by swinging the lid 18 into closed position. The oil is then poured out through the lateral extension 28 and the second filter 32, and is discharged from the second end 28b of the lateral extension 28 after passing through the third filter 34.

It will be readily apparent to those skilled in the art that each embodiment of the hot oil pot provides significant advantages over the prior art.

The first embodiment of the hot oil pot 2 (FIG. 1) provides a filter 14 disposed at the second end 8b of the lateral extension 8. It will be apparent to those skilled in the art that the disposition of the filter 14 at the freely-disposed second end 8b of the lateral extension 8 provides easy access to the filter 14, whereby said filter is readily and easily removable and replaceable. In a preferred embodiment, the first and second portions 8c, 8d of the lateral extension 8 are connected to one another by engaging the matching threads 8e, 8f, and are disconnected from one another by disengaging the matching threads 8e, 8f. In this preferred embodiment, the filter 14 is especially accessible for removal and replacement by engaging and disengaging the first portion 8c of the lateral extension 8, and thereby facilitating access to the filter 14, which is disposed in the second end 8b, for easy removal and replacement of the filter 14.

Both embodiments of the hot oil pot 2 (FIG. 1) and 20 (FIG. 2) provide for series filtration through a plurality of filters. In the most favorable case, assuming, for example, that ninety percent of the particulate solids is removed by the first filter, and ninety percent of the remaining solids is removed by the second filter, the original solids concentration of the used oil would be reduced to ten percent of ten percent; i.e., to one percent. Moreover, passage of the re-filtered oil through a third filter would leave only ten percent of one percent; i.e., one tenth of one percent, of the original solids. In general, such series filtration would, assuming equal efficiencies of all filters, reduce the original solids content of the oil to
Sₙ=S₀Fn

where Sₙ is the solids concentration of the oil after a series of n filtrations through n filters, S₀ is the original solids concentration, and F is the fraction of solids remaining after one filtration. The obvious advantage of this arrangement over the prior art is the exponential reduction of the particulate solids in hot oil by passage of the oil in series through a plurality of filters.

A less favorable case assumes that re-filtration of the filtrate would not reduce the solids concentration of the oil exponentially, because pore size of the filters would limit the extent to which such reduction could be accomplished. Even in this less favorable case, however, there is a sound basis for believing that a significant reduction in solids concentration would be achieved. The reason is that, in addition to the pore size of the filter, the orientation of the particles determines which particles are stopped by, and which particles pass through, the filter.

Even in the least favorable case, if little or no reduction of solids concentration is achieved by re-filtration, multiple filtration through a plurality of filters arranged in series provides fails-safe reduction in solids concentration, because if the first filter is defective, the subsequent re-filtrations would reduce the probability of all of the filters being defective virtually to zero.

The size of the hot oil pot 2, 20 is similar to that of a conventional coffee pot for residential use. While not being restricted to specific dimensions, the hot oil pot 2, 20 must be small enough that it can be lifted, tilted, and manipulated manually by the user.

While certain specific embodiments and details have been used to illustrate the basic principles of the present invention, it will be apparent to those skilled in the art that many modifications of these embodiments and details are possible within the scope of the claimed invention. For example, while hot cooking oil has been used to describe the use of the hot oil pot, such use is by no means restricted or limited to hot oil. In fact, the hot oil pot can be used to process any liquid, hot or cold, containing solid impurities which are to be removed prior to reuse.

1. A hot oil pot, comprising:
(a) a container for the oil, the container including a chamber for retaining the oil, and a lateral extension for discharging the oil from the chamber, the lateral extension having a first end attached to the chamber, and a freely-disposed second end; and
(b) a filter disposed at the second end of the lateral extension, for removing solids from the oil;
the pot being sized, constructed, and arranged so that the pot can be operated at atmospheric pressure, and can be lifted, tilted, and manipulated by hand.

2. The hot oil pot of claim 1, wherein the lateral extension comprises a terminal first portion separable from a remaining second portion of the lateral extension, and the filter is disposed in the separable portion of the lateral extension.

3. The hot oil pot of claim 2, wherein the first and second portions of the lateral extension include matching threads, for connecting the first and second portions to one another by engaging the matching threads, and for disconnecting the first and second portions from one another by disengaging the matching threads.

4. A hot oil pot, comprising:
(a) a container for the oil, the container including a chamber for retaining the oil, and a lateral extension for discharging the oil from the container, the lateral extension having a first end attached to the chamber, and a freely-disposed second end;
(b) a first filter, for filtering the oil; and
(c) a second filter, arranged for series flow through the first filter to and through the second filter, whereby oil that has been filtered by passage through the first filter is re-filtered by passage through the second filter;
the pot being sized, constructed, and arranged so that the pot can be operated at atmospheric pressure, and can be lifted, tilted, and manipulated by hand.

5. The hot oil pot of claim 4, wherein the second filter is disposed at the second end of the lateral extension.

6. The hot oil pot of claim 4, wherein the lateral extension comprises a terminal first portion separable from a remaining second portion of the lateral extension, and the second filter is disposed in the separable portion of the lateral extension.

7. The hot oil pot of claim 4, wherein the first and second portions of the lateral extension include matching threads, for connecting the first and second portions to one another by engaging the matching threads, and for disconnecting the first and second portions from one another by disengaging the matching threads.

8. The hot oil pot of claim 4, further comprising:
(d) a lid, for closing the chamber; and
(e) a cap, attached to the lid, for closing the second end of the lateral extension.

9. The hot oil pot of claim 8, wherein the cap includes the second filter.

10. The hot oil pot of claim 8, further comprising:
(f) means, attached to the cap, for securing the lid and the cap in place.

11. The hot oil pot of claim 1, further comprising:
(c) a lid; and
(d) a cap, attached to the lid, for closing the second end of the lateral extension.

12. The hot oil pot of claim 11, further comprising:
(e) means, attached to the cap, for securing the lid and the cap in place.

13. The hot oil pot of claim 11, wherein the cap includes the filter.
